(19) United States
(12) Patent Application Publication
(10) Pub. No.: US 2026/0204794 A1
(43) Pub. Date: Jul. 16, 2026

(54) RADIO WAVE CONTROL ELEMENT

(71) Applicant: FUJIFILM Corporation, Tokyo (JP)

(72) Inventors: Hideki YASUDA, Minamiashigara-shi (JP); Taketo OTANI, Minamiashigara-shi (JP); Yukito SAITOH, Minamiashigara-shi (JP); Ryoji GOTO, Minamiashigara-shi (JP)

(73) Assignee: FUJIFILM Corporation, Tokyo (JP)

(21) Appl. No.: 19/565,593

(22) Filed: Mar. 13, 2026

Related U.S. Application Data
(63) Continuation of application No. PCT/JP2024/032397, filed on Sep. 10, 2024.

(30) Foreign Application Priority Data
Sep. 21, 2023 (JP) 2023-155578

(51) Int. Cl. H01Q 15/00; H01Q 15/14

(52) U.S. Cl. CPC H01Q 15/0013; H01Q 15/14

(57) ABSTRACT

Provided is a radio wave control element that can shorten a switching time and has a small loss of radio waves. The radio wave control element includes a first electrode, a liquid crystal composition layer, and a second electrode, in which the radio wave control element has a metasurface structure in which a plurality of microstructures are arranged, the metasurface structure constitutes at least a part of the first electrode, and an interlayer in which a maximum refractive index change per unit voltage in radio waves in a wavelength range of 300 μm to 30 cm is 0.001 (1/V) or less is provided between one of the first electrode or the second electrode, and the liquid crystal composition layer.

### CROSS-REFERENCE TO RELATED APPLICATIONS

This application is a Continuation of PCT International Application No. PCT/JP2024/032397 filed on Sep. 10, 2024, which claims priority under 35 U.S.C. § 119(a) to Japanese Patent Application No. 2023-155578 filed on Sep. 21, 2023. The above applications are hereby expressly incorporated by reference, in their entirety, into the present application.

### BACKGROUND OF THE INVENTION

### 1. Field of the Invention

The present invention relates to a radio wave control element.

### 2. Description of Related Art

Radio waves such as high-frequency radio waves (millimeter waves, terahertz waves) required for high-capacity wireless communication have high straightness. Therefore, a radio wave control element that bends traveling directions of radio waves in any direction is required.

However, for example, in a normal reflector, the reflection directions of the radio waves are constant, and the reflection directions are specular reflections where the incidence angle and the emission angle are equal. Therefore, the reflector has a problem in that there is a significant restriction on a range in which the traveling directions of the radio waves are changed and it is difficult to deliver the radio waves to desired places.

In contrast, a radio wave control element has been proposed, which changes a refractive index of a liquid crystal layer to change the directivity of electromagnetic waves by changing a voltage applied between two conductors as a configuration in which a liquid crystal layer is disposed between a metasurface structure consisting of a conductor, and a conductor (electrode).

For example, WO2011/152055A describes a structure including a first conductor, a plurality of second conductors repeatedly disposed, each facing the first conductor, a plurality of third conductors, each facing a respective one of the plurality of second conductors, a dielectric constant variable layer provided at at least one of between the plurality of third conductors and the plurality of second conductors, or between the plurality of third conductors and the first conductor, the dielectric constant variable layer having a dielectric constant that changes depending on a voltage, and a fourth conductor that connects the first of the second conductors and the second of the second conductors positioned adjacent to the first of the second conductors.

### SUMMARY OF THE INVENTION

In a radio wave control element, it is desired to shorten a switching time in a case of changing the directivity of radio waves. In the radio wave control element in which a liquid crystal layer is disposed between conductors as described above, the switching time can be shortened by reducing the thickness of the liquid crystal layer. However, there is a problem that the loss of radio waves increases in a case where the thickness of the liquid crystal layer is reduced.

In view of these circumstances, an object of the present invention is to provide a radio wave control element that can shorten a switching time and has a small loss of radio waves.

The present inventors have conducted intensive studies to achieve the object, and as a result, have found that the object can be accomplished by the following configurations.

[1] A radio wave control element including:
a first electrode;
a liquid crystal composition layer; and
a second electrode,
in which the radio wave control element has a metasurface structure in which a plurality of microstructures are arranged,
the metasurface structure constitutes at least a part of the first electrode, and
an interlayer in which a maximum refractive index change per unit voltage in radio waves in a wavelength range of 300 μm to 30 cm is 0.001 (1/V) or less is provided between one of the first electrode or the second electrode and the liquid crystal composition layer.

[2] The radio wave control element according to [1], further including:
a waveguide that guides radio waves on a side of the second electrode opposite to a liquid crystal composition layer side,
in which the second electrode has an opening through which the radio waves pass.

[3] The radio wave control element according to [2],
in which the second electrode also serves as the waveguide.

[4] The radio wave control element according to any one of [1] to [3],
in which a thickness of the interlayer is 0.1 to 2 times a thickness of the liquid crystal composition layer.

[5] The radio wave control element according to any one of [1] to [4],
in which the radio wave control element controls radio waves in a wavelength range of 300 μm to 30 cm.

According to the present invention, it is possible to provide a radio wave control element that can shorten a switching time and has a small loss of radio waves.

### BRIEF DESCRIPTION OF THE DRAWINGS

FIG. 1 is a view showing a use example of a radio wave control element.

FIG. 2 is a view showing an example of a metasurface structure used in a radio wave control element.

FIG. 3 is a view showing a mechanism by which emission directions of radio waves are changed in a radio wave control element.

FIG. 4 is a view conceptually showing an example of a radio wave control element of an embodiment of the present invention.

FIG. 5 is a view conceptually showing an example of a liquid crystal alignment pattern in a radio wave control element.

FIG. 6 is a view showing a relationship between an applied voltage and a delay amount of a phase of a radio wave.

FIG. 7 is a view conceptually showing another example of a radio wave control element.

FIG. 8 is a perspective view of the radio wave control element shown in FIG. 7.

### DESCRIPTION OF THE PREFERRED EMBODIMENTS

Hereinafter, the present invention will be described in detail.

Descriptions of the constitutional requirements described later are made based on representative embodiments of the present invention in some cases, but it should not be construed that the present invention is limited to such embodiments.

Furthermore, in the present specification, a numerical range expressed using “to” refers to a range including numerical values described before and after “to” as a lower limit value and an upper limit value.

In addition, in the present specification, the terms horizontal and vertical do not mean horizontal and vertical in a strict sense, respectively, but mean a range of horizontal±5° and a range of vertical±5°, respectively.

Moreover, in the present specification, materials corresponding to respective components may be used alone or in combination of two or more kinds thereof. Here, in a case where the two or more kinds of the substances are used in combination for each component, the content of the component refers to a total content of the substances used in combination unless otherwise specified.

In the present specification, the bonding direction of a divalent group denoted (for example, —CO—O—) is not limited unless otherwise specified. For example, in a case where Y in a compound represented by Formula “X-Y-Z” is —CO—O—, the compound may be any of “X—O—CO—Z” or “X—CO—O—Z”.

### [Radio Wave Control Element]

The radio wave control element of an embodiment of the present invention is
a radio wave control element including a first electrode, a liquid crystal composition layer, and a second electrode,
in which the radio wave control element has a metasurface structure in which a plurality of microstructures are arranged,
the metasurface structure constitutes at least a part of the first electrode, and
an interlayer in which a maximum refractive index change per unit voltage in radio waves in a wavelength range of 300 μm to 30 cm is 0.001 (1/V) or less is provided between one of the first electrode or the second electrode, and the liquid crystal composition layer.

The radio wave control element of the embodiment of the present invention acts on radio waves (electromagnetic waves). Examples of the radio waves include radio waves having a frequency of 1 GHz to 1,000 GHz, that is, a wavelength of 300 μm to 30 cm. The radio waves RW in this frequency band are also referred to as high-frequency radio waves (centimeter waves, millimeter waves, or terahertz waves), or the like, and are capable of performing high-capacity wireless communication, but have high straightness.

In the radio wave control element of the embodiment of the present invention, by applying a voltage between the first electrode and the second electrode, the alignment state of the liquid crystal compounds included in the liquid crystal composition layer is controlled to adjust the refractive index anisotropy of the liquid crystal composition layer, whereby the traveling directions of the radio waves can be adjusted.

Hereinafter, specific examples of the radio wave control element will be described with reference to the drawings.

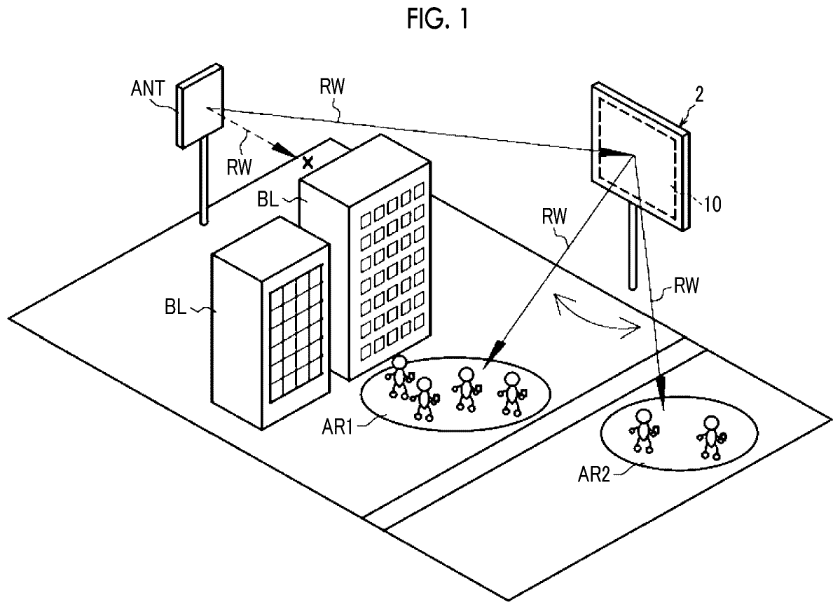

A radio wave control element 10 according to the present disclosed technology is used in a radio wave reflection device 2 shown in FIG. 1. The radio wave reflection device 2 is capable of reflecting radio waves RW having high straightness, which are radiated from an antenna ANT disposed behind the building BL, toward an area AR1 in front of the building BL which is in the shadow as viewed from the antenna ANT.

In addition, the radio wave reflection device 2 is capable of changing the reflection directions of the radio waves RW in different directions of the plurality of areas AR1 and the areas AR2. For example, areas where many users utilizing wireless communication are present sometimes change depending on the time slot of the day, such as the area AR1 where many users are present in the day time slot and the area AR2 where many users are present in the night time slot. In such a case, the radio wave reflection device 2 is capable of changing the area to which the radio waves RW are supplied by changing the reflection directions of the radio waves RW according to the time slot.

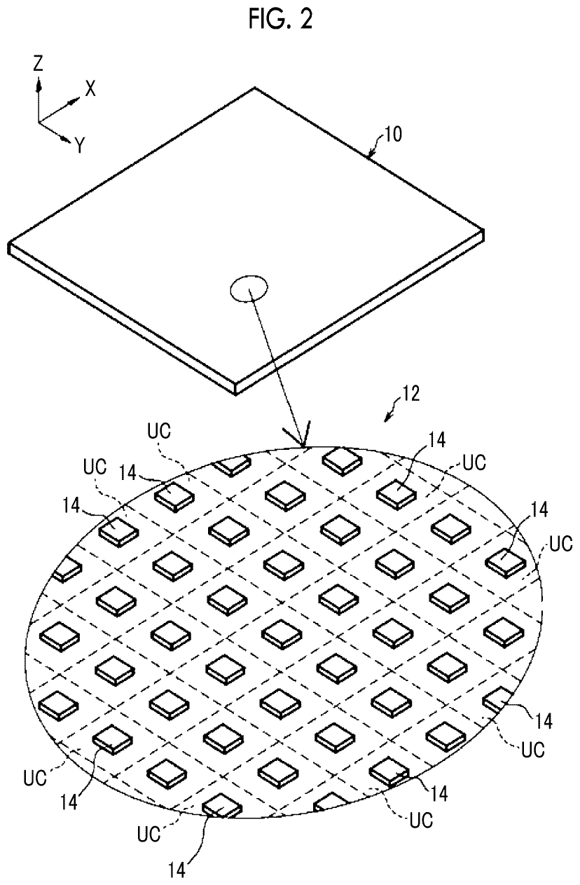

As shown in FIG. 2, the radio wave control element 10 has a metasurface structure 12, and is a reflective radio wave control element that reflects the traveling direction of a radio wave RW in a desired direction.

The metasurface structure 12 is a structure that uses a metamaterial. The metamaterial refers to an artificial substance exhibiting characteristics not found in a substance in nature, such as a negative refractive index with respect to a radio wave. The radio wave control element 10 has a configuration in which a plurality of unit cells UC are two-dimensionally arranged, and a two-dimensional plane formed by the arrangement of the plurality of unit cells UC serves as a reflecting surface of the radio wave RW. Each unit cell UC includes a microstructure 14 as the metamaterial, and constitutes a minimum unit capable of actively changing the phase of the radio wave RW on the reflecting surface. The microstructure 14 is made of a metal, for example. The microstructure 14 has a size of the order of the wavelength or less of the incident radio wave RW and functions as a resonator that resonates due to interaction with the incident radio wave RW. The microstructure 14 can be considered to be, for example, electrically equivalent to a resonance circuit in which a coil and a capacitor are connected in series and an alternating current is resonated. The phase of the incident radio wave RW changes due to the resonance action of the microstructure 14. Furthermore, by actively changing the resonance condition of the microstructure 14 by various methods, it is also possible to control the delay amount of the phase of the radio wave RW.

The radio wave control element 10 mainly acts on a radio wave RW having a frequency of 1 GHz to 1,000 GHz (1 THz). Accordingly, in the radio wave control element 10, the metasurface structure 12 is configured to act on the radio wave RW having a frequency of 1 GHz to 1,000 GHz. The wavelength of the radio wave RW having a frequency of 1 GHz to 1,000 GHz is 300 μm to 30 cm, and the size of the microstructure 14 constituting the metasurface structure 12 is, for example, on the order of approximately ½ of the wavelength. By setting the size of the microstructure 14 to be equal to or less than the wavelength of the radio wave RW, the microstructure 14 resonates with the radio wave RW transmitted therethrough and functions as a phase modulation element that modulates the phase of the radio wave RW.

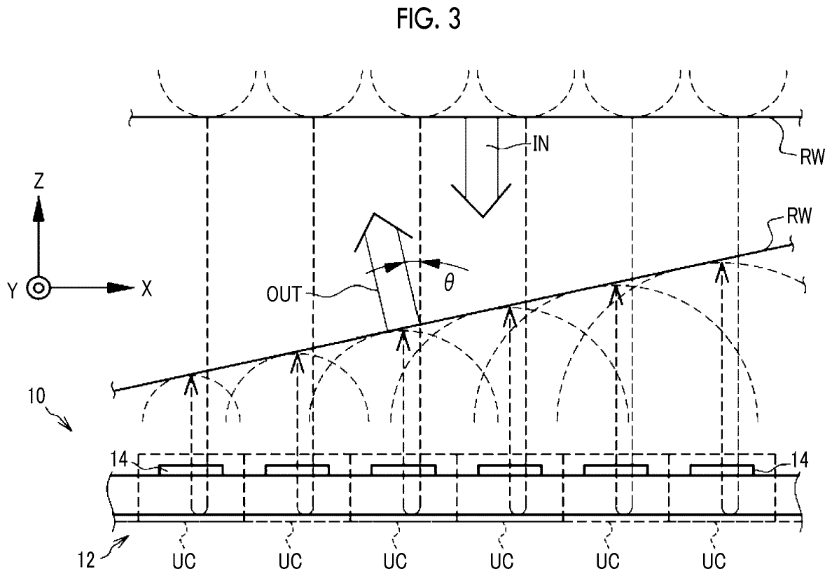

In FIG. 3, as exemplified by the incidence direction IN and the emission direction OUT, an overall traveling direction of radio waves RW can be considered to be a normal direction with respect to a straight line connecting the wavefronts of the plurality of radio waves RW. Furthermore, in the radio wave control element 10, for example, it is considered that the delay amount of the phase of the radio wave RW incident on and reflected from each of the plurality of unit cells UC arranged in one dimension gradually increases from the unit cell UC in the right direction to the unit cell UC in the left direction. Then, even in a case where a straight line connecting the wavefronts of the individual incident radio waves RW is parallel to the reflecting surface, the straight line connecting the wavefronts of the individual radio waves RW reflected by each unit cell UC is inclined with respect to the reflecting surface. That is, the emission direction OUT, which is a traveling direction of the radio wave RW emitted from the reflecting surface, is changed by an angle θ with respect to the incidence direction IN of the radio wave RW. In this way, the traveling direction of the radio wave RW can be controlled by performing the phase modulation, that is, controlling the delay amount of the phase for each unit cell UC.

As a result, in a normal reflector, the traveling direction of the radio wave RW can only be changed toward the direction of specular reflection, while in the radio wave reflection device 2, it is possible to change the traveling direction of the radio wave RW toward directions other than specular reflection by using the metasurface structure 12. In addition, it is possible to actively change the traveling direction of the radio wave RW by actively changing the delay amount of the phase in each unit cell UC.

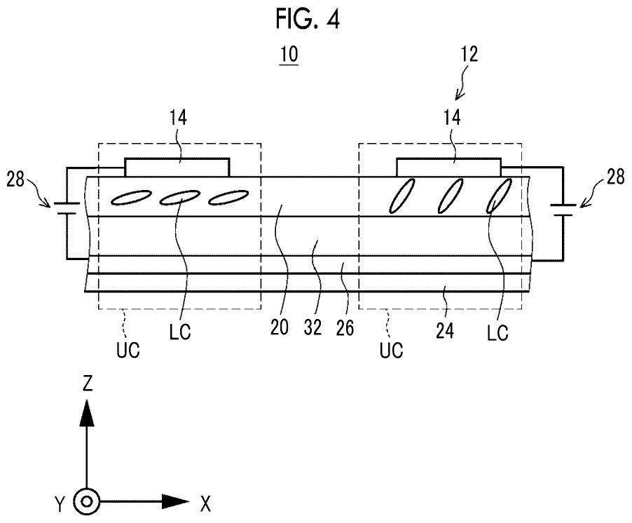

As conceptually shown in FIG. 4 as an example, the radio wave control element 10 uses the liquid crystal composition layer 20 as an element that actively changes resonance conditions of the microstructure 14 of the metasurface structure 12. The radio wave control element 10 has a second electrode 26, an interlayer 32, a liquid crystal composition layer 20, and a metasurface structure 12 in this order from the lower side in the drawing. The second electrode 26, the liquid crystal composition layer 20, and the interlayer 32 are provided on a support 24.

Each unit cell UC is configured to include the microstructure 14, the liquid crystal composition layer 20, the interlayer 32, and the second electrode 26. Among these, the microstructure 14 is individually provided for each unit cell UC. The liquid crystal composition layer 20, the interlayer 32, the support 24, and the second electrode 26 other than those described above are not independently formed for each unit cell UC, and regions corresponding to a plurality of unit cells UC are integrally formed.

In the radio wave control element 10, the second electrode 26 and the support 24, the second electrode 26 and the interlayer 32, and the interlayer 32 and the liquid crystal composition layer 20 are bonded to each other using a bonding agent (a pressure sensitive adhesive or an adhesive) as necessary. The bonding method is not limited, and various known methods in which radio waves targeted by the radio wave control element 10 can be transmitted, such as a method using an optical clear adhesive (OCA) through which radio waves targeted by the radio wave control element 10 can be transmitted, can be used.

The microstructure 14 is formed of a conductive material as an example, and also serves as a first electrode that constitutes the electrode pair together with the second electrode 26.

In addition, a power supply 28 for applying a voltage between the microstructure 14 and the second electrode 26 is connected to each of the microstructures 14. Therefore, it is possible to control the magnitude of the voltage applied to each unit cell UC. The second electrode 26 is a common electrode common to each unit cell UC, and the microstructure 14 of each unit cell UC functions as an individual electrode. The second electrode 26 that functions as a common electrode is an example of a “second electrode” according to the present disclosed technology, and the individual electrode that is also used by the microstructure 14 is an example of the “first electrode”. The microstructure 14 as the first electrode and the second electrode 26 as the second electrode are an example of an “electrode pair for applying a voltage”.

A voltage applying unit that applies a voltage to each of the microstructures 14 is not particularly limited, and examples thereof include a thin film transistor (TFT).

The radio wave control element 10 is a reflective type, and the second electrode 26 also serves as a reflective layer that reflects the radio waves RW.

In the liquid crystal composition layer 20, the alignment state (hereinafter also referred to as an alignment pattern) of liquid crystal compounds LC changes by the application of a voltage. The arrangement direction of the microstructure 14 of each unit cell UC is a direction (the X direction or the Y direction in the drawing) orthogonal to the thickness direction (the Z direction in the drawing) of the liquid crystal composition layer 20. Here, the microstructure 14 and the second electrode 26 are disposed on both surfaces of the liquid crystal composition layer 20 in the thickness direction. By supplying electric power from the power supply 28 to the microstructure 14 and the second electrode 26, a voltage is applied between the microstructure 14 of each unit cell UC and the second electrode 26. By applying a voltage, an electric field is generated in the thickness direction of the liquid crystal composition layer 20, and the alignment state of the liquid crystal compounds LC in each unit cell UC changes. In addition, the alignment state of the liquid crystal compounds LC in each unit cell UC can be adjusted by adjusting the voltage applied to each unit cell UC.

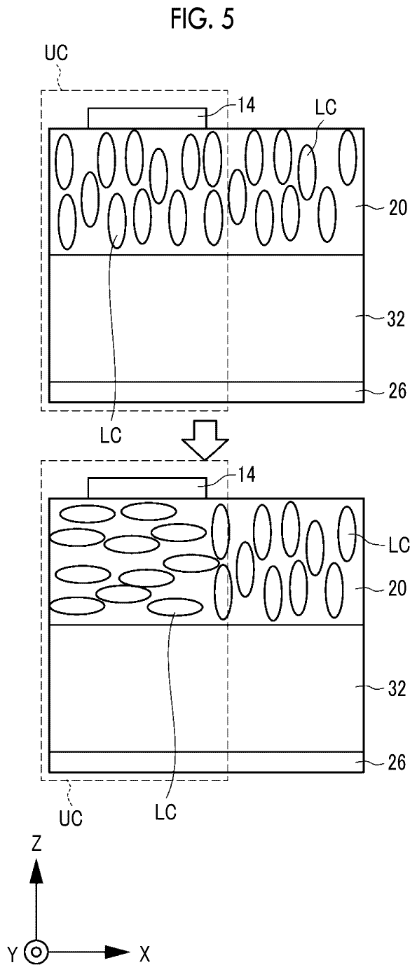

In the example shown in FIG. 5, the liquid crystal compound LC is a rod-like liquid crystal compound, and has a major axis and a minor axis. As an example, in a state where no voltage is applied between the microstructure 14 that functions as an electrode pair and the second electrode 26, an electric field is not generated in the liquid crystal composition layer 20. In this state, as conceptually shown in an upper part of FIG. 5, the liquid crystal compounds LC are aligned in a posture in which the major axis is parallel to the thickness direction of the liquid crystal composition layer 20. In the following description, this alignment state is also referred to as a “vertical alignment”.

Furthermore, the thickness direction is a lamination direction of the microstructure 14 (first electrode), the liquid crystal composition layer 20, the interlayer 32, and the second electrode 26. In addition, the main surface is a maximum surface of a sheet-like material (a film, a plate-like material, or a layer), and is usually on both surfaces of the sheet-like material in a thickness direction.

In a case where a voltage is applied between the microstructure 14 and the second electrode 26 from this state, an electric field is generated in the liquid crystal composition layer 20 and the alignment state of the liquid crystal compounds LC changes. Specifically, as conceptually shown in the lower part of FIG. 5, the alignment state of the liquid crystal compounds LC in the region corresponding to the microstructure 14 changes depending on a magnitude of the applied voltage, and is tilted with respect to the thickness direction of the liquid crystal composition layer 20. In the example shown in the lower part of FIG. 5, a state where the tilt angle of the liquid crystal compound LC is at the maximum is shown. In a state where the tilt angle is the maximum, the liquid crystal compounds LC are aligned in a posture in which the major axis is parallel to a direction orthogonal to the thickness direction of the liquid crystal composition layer 20. In the following description, the alignment state where the tilt angle is at the maximum is also referred to as “horizontal alignment”.

As the tilt of the liquid crystal compound LC increases, that is, the angle of the major axis of the liquid crystal compound LC is closer to the main surface direction (the X direction or the Y direction in FIG. 5) of the liquid crystal composition layer 20, the refractive index of the liquid crystal composition layer 20 increases. On the contrary, as the tilt of the liquid crystal compound LC decreases, that is, the angle of the major axis of the liquid crystal compound LC is closer to the thickness direction (Z direction in the drawing) of the liquid crystal composition layer 20, the refractive index of the liquid crystal composition layer 20 decreases. Due to such a change in the refractive index of the liquid crystal composition layer 20 of each unit cell UC, the resonance condition of the microstructure 14 changes and the delay amount of the phase of the incident radio wave RW changes. In the present example, the delay amount of the phase of the lower unit cell UC of FIG. 5 is larger than that of the upper unit cell UC of FIG. 5.

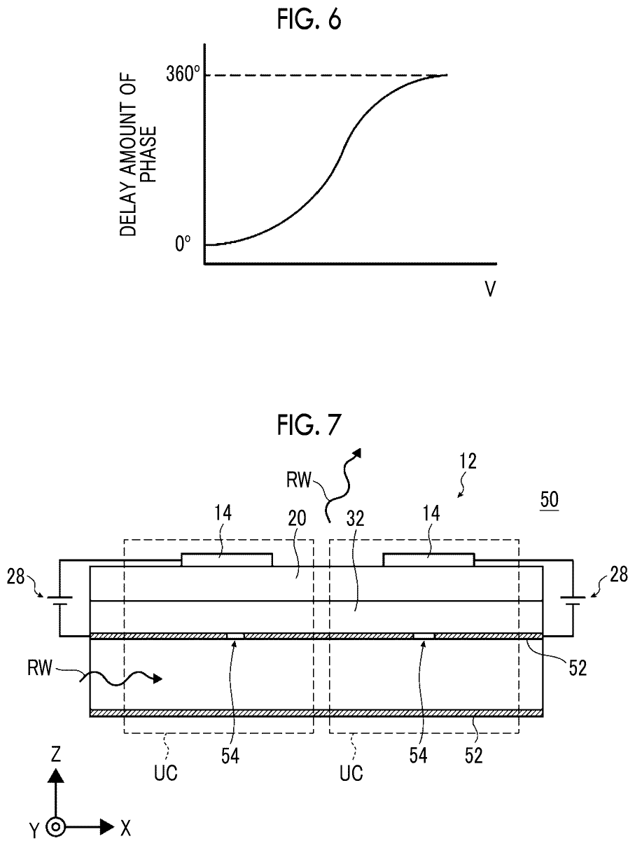

That is, in the liquid crystal composition layer 20 positioned at the position corresponding to the microstructure 14 of each unit cell UC and in a periphery thereof, in a case where the alignment state of the liquid crystal compounds LC changes, the refractive index of the liquid crystal composition layer 20 with respect to the radio wave RW transmitted through each unit cell UC changes. Furthermore, since the refractive index and the dielectric constant have a positive correlation, the resonance condition of the microstructure 14 that functions as a resonator changes due to the change in the refractive index of the liquid crystal composition layer 20. The change in the resonance condition of the microstructure 14 appears as a change in the delay amount of the phase of the radio wave RW. Therefore, the delay amount of the phase of the radio wave RW can be changed by changing the refractive index of the liquid crystal composition layer 20. In addition, the change in the refractive index of the liquid crystal composition layer 20 also causes a change in the delay amount of the phase of the radio wave RW. Since the refractive index of the liquid crystal composition layer 20 of each unit cell UC changes depending on the voltage V applied to each unit cell UC, the relationship between the voltage V and the delay amount of the phase of the radio wave RW is as shown in FIG. 6 as an example.

As shown in FIG. 3, in a case where the radio waves RW are incident on the radio wave control element 10 from the microstructure 14 side, the radio waves RW are transmitted through the microstructure 14 and the liquid crystal composition layer 20 in this order. Furthermore, the radio waves RW are reflected from the second electrode 26 that serves as a reflective layer, and transmitted again through the liquid crystal composition layer 20 and the microstructure 14 in this order, thereby being emitted from the radio wave control element 10. The radio waves RW are reflected through such incidence and emission paths. In the incidence and emission paths, for the radio waves RW transmitted through each unit cell UC, the phase modulation due to the resonance by the microstructure 14 and the phase modulation due to the transmission through the liquid crystal composition layer 20 occur. More specifically, in each unit cell UC, the resonance condition of the microstructure 14 is determined according to the refractive index of the liquid crystal composition layer 20, and the phase modulation of the radio waves RW occurs due to the resonance under the condition. In addition, the phase modulation of the radio waves RW depending on a magnitude of the refractive index of the liquid crystal composition layer 20 also occurs.

By controlling the delay amount of the phase of the radio wave RW for each unit cell UC through the applied voltage V based on the relationship shown in FIG. 6, the reflection direction of the radio wave RW reflected by the radio wave control element 10 is controlled.

As shown in FIG. 3, in a normal reflector, the traveling direction of the radio wave RW can only be changed toward the direction of specular reflection, while in the radio wave control element 10, it is possible to change the traveling direction of the radio wave RW toward directions other than specular reflection by using the metasurface structure 12. In addition, it is possible to actively change the traveling direction of the radio wave RW by actively changing the delay amount of the phase in each unit cell UC.

Furthermore, for the control of the traveling direction of the radio waves RW emitted from the radio wave control element 10, various examples can be considered, in addition to the control of the reflected radio waves RW to travel in one direction as a whole as in the example shown in FIG. 3. For example, the radio waves RW emitted from the radio wave control element 10 may converge toward a single focal point, or conversely, may diverge from the focal point. The control of the traveling direction of the emitted radio wave RW can be performed by adjusting a voltage applied to each unit cell UC to adjust the delay amount of the phase of the radio wave RW of each unit cell UC.

For example, in a case where there are a plurality of unit cells UC arranged in one direction as shown in FIG. 3, it is considered that the delay amount of the phase of the central unit cell UC is increased and the delay amount of the phase is decreased toward both sides. In this case, the wavefronts of the radio waves RW transmitted through each unit cell UC are connected to each other to have a V-shape, and therefore, the radio waves RW to be emitted can converge. In addition, on the contrary, it is considered that the delay amount of the phase of the central unit cell UC is decreased and the delay amount of the phase is increased toward both sides. In this case, the wavefronts of the radio waves RW transmitted through each unit cell UC are connected to each other to have a chevron shape (reverse V-shape), and therefore, the radio waves RW to be emitted can diverge. The degrees of convergence and divergence can also be adjusted by controlling the delay amount of the phase of the radio wave RW transmitted through each unit cell UC through adjustment of the magnitude of the applied voltage.

The metasurface structure 12 is formed by two-dimensionally arranging the microstructures 14, which are metamaterials, in the same manner as a known metasurface structure. In the metasurface structure 12 in the example shown in the drawing, the microstructures 14 are two-dimensionally arranged at regular intervals in the X direction and the Y direction, which are orthogonal to each other as shown in FIG. 2. In addition, in the metasurface structure 12, the microstructures 14 are all the same, for example. In addition, the metasurface structure 12 constitutes at least a part of the first electrode. That is, as described above, each of the plurality of microstructures 14 constituting the metasurface structure 12 is the first electrode in each unit cell UC. In addition, the metasurface structure 12 (microstructure 14) may be supported by a support.

The support that supports the microstructure 14 is not limited, and various known sheet-like materials can be used as long as the microstructure 14 can be supported and the radio wave RW having a frequency of 1 GHz to 1,000 GHz targeted by the radio wave control element 10 can be transmitted. Examples of the support include a metal substrate having an oxide insulating layer, such as a silicon substrate having silicon oxide, a support consisting of an oxide such as silicon oxide, a support consisting of a semiconductor such as germanium and chalcogenide glass, a polyacrylic resin film such as polymethyl methacrylate, a cellulose resin film such as cellulose triacetate, a cycloolefin polymer-based film (for example, product name “ARTON”, manufactured by JSR Corporation, product name “ZEONOR”, manufactured by Zeon Corporation), a polyethylene terephthalate (PET) film, a polycarbonate film, a resin film such as a polyvinyl chloride film, and a glass plate.

A thickness of the support is not limited, and may be any thickness as long as the support can support the microstructures 14, a sufficient transmittance can be obtained for the radio wave RW having a frequency of 1 GHz to 1,000 GHz, and a sufficient strength can be obtained depending on the use of the radio wave control element 10, and the like. The thickness of the support is appropriately set according to a material for forming the support to satisfy such conditions.

Furthermore, in the radio wave control element 10 according to the present disclosed technology, the support is not in an essential configuration in the metasurface structure 12, and the support may not be provided. For example, the metasurface structure 12 may be formed by directly arranging the microstructures 14 on a surface of the liquid crystal composition layer 20, if possible. In a case where a support is provided, a configuration in which the support is provided between the metasurface structure 12 and the liquid crystal composition layer 20 may be adopted, or a configuration in which the support is provided on a surface side of the metasurface structure 12 opposite to the liquid crystal composition layer 20 side may be adopted.

As described above, the metasurface structure 12 is formed by two-dimensionally arranging the microstructures 14, which are the metamaterials, on a plane to be spaced, and more specifically, is configured by an arrangement of unit cells UC, each of which is a unit of one microstructure 14 and a space around the microstructure 14.

In the radio wave control element 10 according to the present disclosed technology, the form of the metasurface structure is basically the same as that of the known metasurface structure. Accordingly, in the radio wave control element 10 of the present disclosed technology, various known metasurface structures can be used.

That is, in the present disclosed technology, the shape and the material for forming the microstructure 14, the arrangement of the microstructures 14, a pitch which is the interval of the microstructures 14, and the like are not limited. In addition, the metasurface structure 12 may be designed by a known method according to the wavelength of the radio wave RW to be controlled and the target reflection characteristics (for example, the range of a controllable reflection direction) of the radio wave control element 10. As an example, the amplitude and the phase of the radio waves RW reflected by the microstructure 14 to be used may be calculated using commercially available simulation software, and the arrangement of the microstructures 14 may be set to obtain a desired distribution of the phase modulation amount. In a case where the liquid crystal composition layer 20 is used as in the present example, the phase modulation is generated by the refractive index and further by an interaction between the refractive index and the microstructure 14, and the phase modulation amount is determined by the resonance characteristics of the microstructure 14 that change depending on the refractive index.

The radio wave control element 10 according to the present disclosed technology targets the control of a radio wave RW having a frequency of 1 GHz to 1,000 GHz. Accordingly, in the metasurface structure 12, the microstructure 14 is selected such that a desired phase difference is imparted to the radio wave RW having the frequency, and further, the arrangement of the microstructures, and the like are set. Specifically, in a case where the radio wave RW having a frequency of 1 GHz to 1,000 GHz is targeted for the control, the wavelength range of the radio waves RW is approximately 300 μm to 30 cm, and thus the size of the microstructure 14 is also selected to be equal to or smaller than the wavelength range.

The number of the microstructures 14 contained in one unit cell UC is basically one, but the present disclosed technology is not limited thereto. That is, in the radio wave control element according to the present disclosed technology, one unit cell UC may have a plurality of the microstructures 14, as necessary, depending on the reflection characteristics, size, forming materials, and shape of the microstructure 14, the size of the unit cell UC, and the like. In this case, one unit cell UC may have different microstructures 14. It should be noted that since the unit cell UC is the minimum unit capable of actively changing the phase of the radio wave RW, even in a case where one unit cell UC has a plurality of the microstructures 14, the phase modulation amount is determined for each unit cell UC.

In addition, the material for forming the microstructure 14 is not limited, and various materials that are used as a microstructure in known metasurface structures can be used. Examples of the material for forming the microstructure 14 include a metal and a dielectric. In a case of the metal, preferred examples of the material include copper, gold, and silver from the viewpoint of low optical loss. In addition, as the material for forming the microstructure 14, a composite body consisting of metal particles and a binder, and an oxide semiconductor can also be used. On the other hand, in a case of the dielectric, silicon, titanium oxide, and germanium are preferably exemplified in consideration of the views that for example, the refractive index is high and the phase modulation amount can be increased. Furthermore, as shown in FIG. 4, in a case where the microstructure 14 also serves as an electrode forming an electrode pair together with the second electrode 26, the microstructure 14 is formed of a conductor.

Similarly, the shape of the microstructure 14 is also not limited, and various shapes that are used as the microstructure in a known metasurface structure can be used. Examples of the shape include a cross-like three-dimensional structure in which cuboids intersect with each other, a cuboid shape, a cylindrical shape, a V-like three-dimensional structure in which cuboids are connected to end parts as described in JP2018-046395A, an H-like three-dimensional structure such as H-steel, and a substantially C-like three-dimensional structure such as a C-channel. In addition, as shown in JP2018-046395A, various shapes where an angle between two cuboids is adjusted can be used as the V-like three-dimensional structure and the cross-like three-dimensional structure. In addition to those, the three-dimensional structure having a bottom surface shape as shown in Figure. 5 of “Appl. Sci. 2018, 8(9), 1689; https://doi.org/10.3390/app8091,689”, or the like can also be used.

In the metasurface structure 12, the same kind of such microstructures 14 may be used or a plurality of kinds of the microstructures 14 may be used in combination. In addition, the same microstructures 14 may be arranged in the same orientation or may be arranged in different orientations in the XY plane. Moreover, there may exist a mixture of the ones in the same orientation and the ones in different orientations. However, in the radio wave control element 10 according to the present disclosed technology, it is preferable that only one kind of the microstructures 14 are used and all the microstructures 14 are arranged in the same orientation.

In addition, as shown in FIG. 3, in a preferred aspect of the metasurface structure 12, the same microstructures 14, all having the same structure, are two-dimensionally arranged at regular intervals in the X direction and the Y direction, which are orthogonal to each other. However, the present disclosed technology is not limited thereto. A plurality of kinds of the microstructures may be used in combination as described above, and the arrangement interval and the arrangement of the microstructures 14 may also be different in the plane direction. It should be noted that in consideration of the controllability of the reflection directions of the radio waves RW in a case where a voltage is applied to the liquid crystal composition layer 20, it is preferable that the metasurface structure 12 is formed of the same microstructures 14. Furthermore, in the metasurface structure 12, the intervals between the microstructures 14 are more preferably equal intervals, and are still more preferably equal intervals in both the X direction and the Y direction, which are orthogonal to each other.

The liquid crystal composition layer 20 is a layer formed by aligning the liquid crystal compounds LC in a predetermined state, and as described above, the alignment state of the liquid crystal compounds LC changes by applying a voltage.

In the liquid crystal composition layer 20 shown in FIG. 4, the liquid crystal compounds LC are vertically aligned in a state where no voltage is applied. In a case where a voltage is applied to the liquid crystal composition layer 20, the liquid crystal compounds LC are aligned to be tilted with respect to the thickness direction depending on the voltage and reaches a horizontal alignment at the maximum. Furthermore, in the radio wave control element 10, the change in the alignment of the liquid crystal compounds LC is not limited to a change from the vertical alignment to the horizontal alignment or vice versa, may be a change from a state of being tilted with respect to the thickness direction to the horizontal alignment or the vertical alignment, may be a change from the horizontal alignment or the vertical alignment to a state of being tilted with respect to the thickness direction, or may be a change in the angle from a state of being tilted with respect to the thickness direction to a state of being tilted with respect to the thickness direction.

In addition, the liquid crystal composition layer 20 may be formed on a surface of the alignment film described later by a known method.

In the radio wave control element 10, the liquid crystal composition layer 20 is laminated on the second electrode 26 or the interlayer 32 on the support 24. The support 24 is basically the same as the above-described support.

Here, in a case where the liquid crystal composition layer 20 is formed on the second electrode 26 or the interlayer 32, an alignment film for aligning the liquid crystal compounds LC in a predetermined state may be provided on a surface of the second electrode 26 or the interlayer 32. As the alignment film, various known films can be used. Examples of the alignment film include a rubbing-treated film consisting of an organic compound such as a polymer, an obliquely vapor-deposited film with an inorganic compound, a film having a microgroove, and a film formed by lamination of Langmuir-Blodgett (LB) films formed with a Langmuir-Blodgett method using an organic compound such as @-tricosanoic acid, dioctadecylmethylammonium chloride, and methyl stearate. In addition, as the alignment film, a so-called photo-alignment film obtained by irradiating a photo-alignable material with polarized light or non-polarized light can be used. These alignment films may be formed by a known method depending on a material for forming the main body.

Alternatively, in a case where a support that supports the microstructure 14 is provided, the liquid crystal composition layer 20 may be formed on the support.

A liquid crystal composition for forming the liquid crystal composition layer 20, the composition including a liquid crystal compound LC, will be described later.

The entire surface of the support 24 on the liquid crystal composition layer 20 side is covered with the second electrode 26. The second electrode 26 is an electrode that changes the alignment of the liquid crystal compounds LC in the liquid crystal composition layer 20, and also acts as a reflective layer that reflects a radio wave RW having a frequency of 1 GHz to 1,000 GHz incident from the metasurface structure 12 side, as described above. Furthermore, in the example shown in the drawing, the second electrode 26 is disposed between the support 24 and the liquid crystal composition layer 20; however, this is not limiting. The second electrode 26 may be disposed on a surface of the support 24 opposite to the liquid crystal composition layer 20 side.

The second electrode 26 is not limited, and a sheet-like material consisting of various known materials can be used as long as it has sufficient conductivity and can reflect radio waves RW.

Examples of the second electrode 26 include metal layers such as copper, aluminum, gold, and silver, inorganic conductive materials such as indium tin oxide (ITO), organic conductive materials such as polythiophene typified by poly(3,4-ethylenedioxythiophene) (PEDOT), and graphene. The inorganic conductive material, the organic conductive material, the graphene, and the like are transparent to visible light, but act as a reflective layer with respect to the radio waves having the frequency.

A thickness of the second electrode 26 is not limited, and the thickness with which radio waves as a target can be reflected with a required reflectivity may be appropriately set depending on a material for forming the second electrode 26.

As described above, the radio wave control element 10 according to the present disclosed technology is a reflective radio wave control element having the metasurface structure 12 and the liquid crystal composition layer 20. In the radio wave control element 10, by supplying power to each of the microstructures 14 to change the alignment state of the liquid crystal compounds LC in the corresponding region of the liquid crystal composition layer 20, regions having different refractive indices are formed for each unit cell UC, and the radio waves RW are reflected in desired directions. In addition, the reflection directions of the incident radio waves RW can be switched by changing the power supplied to each of the microstructures 14, that is, the voltage applied to the liquid crystal composition layer 20.

In the radio wave control element 10 according to the present disclosed technology, the refractive index anisotropy Δn of the liquid crystal composition layer 20 with respect to the radio wave is not particularly limited, but is preferably high. Here, in the reflective radio wave control element 10 of the present example, the refractive index anisotropy Δn of the liquid crystal composition layer 20 with respect to the radio wave of 100 GHz is preferably 0.35 or more. From the viewpoint that the liquid crystal composition layer 20 can be made thin, and thus the switching of the reflection direction of the radio wave RW can be performed more quickly, it is preferable to set the refractive index anisotropy Δn of the liquid crystal composition layer 20 with respect to the radio wave of 100 GHz to 0.35 or more.

In addition, the thickness of the liquid crystal composition layer 20 is not limited, and the thickness for imparting a phase difference required for the radio wave RW may be appropriately set depending on a material for forming the liquid crystal composition layer 20. Here, as will be described later, the radio wave control element 10 according to the present disclosed technology includes the interlayer 32 in which the refractive index does not change. Therefore, even in a case where the liquid crystal composition layer 20 is made thin to shorten the time for switching the reflection direction of the incident radio wave RW, that is, even in a case where the response speed is increased, the loss of the radio wave RW can be reduced. In consideration of this viewpoint, the thickness of the liquid crystal composition layer 20 is preferably 200 μm or less, more preferably 150 μm or less, and still more preferably 100 μm or less. From the viewpoint that the switching of the reflection direction of the radio wave RW can be performed more quickly, it is preferable to set the thickness of the liquid crystal composition layer 20 to 200 μm or less.

In addition, Δn (birefringence) of the liquid crystal composition layer 20 is not limited, but is preferably high. The Δn of the liquid crystal composition layer is preferably 0.35 or more. It is preferable that Δn of the liquid crystal composition layer is set to 0.35 or more from the viewpoint that the liquid crystal composition layer can be made thin and the switching of the traveling direction of the radio wave can be performed more quickly.

The interlayer 32 is a layer in which the maximum change in refractive index per unit voltage in radio waves in a wavelength range of 300 μm to 30 cm is 0.001 (1/V) or less. That is, the interlayer 32 is a layer in which the refractive index does not change depending on the voltage. In addition, the interlayer 32 is a layer having insulating properties. The maximum change in refractive index per unit voltage of the interlayer 32 in radio waves in a wavelength range of 300 μm to 30 cm is preferably 0.0005 (1/V).

In the present disclosure, the maximum change in refractive index per unit voltage in radio waves in a wavelength range of 300 μm to 30 cm is measured by terahertz time-domain spectroscopy (THz-TDS) as follows.

First, the interlayer is cut into a test piece having a size of 10 mm×10 mm and a thickness of 1 mm. Next, tin oxide (SnO₂) films are formed on both surfaces of the interlayer by a sputtering method. Next, an optical system for transmission-type terahertz spectroscopy is manufactured, and a refractive index of the test piece is measured from a change in time waveform of the optical electric field transmitted through the test piece in a case where a voltage is applied to the tin oxide film in an environment of a temperature of 25° C. and a humidity of 10% RH.

In a case of a liquid crystal composition layer, first, a liquid crystal composition is sealed in a glass cell (10 mm×10 mm, thickness: 1 mm) in which a tin oxide (SnO₂) film is formed as an electrode by a sputtering method. Next, an optical system for transmission-type terahertz spectroscopy is manufactured, and a refractive index of the liquid crystal composition enclosed in the glass cell is measured from a change in time waveform of the optical electric field of light transmitted through the test piece in a case where a voltage is applied to the electrode in an environment of a temperature of 25° C. and a humidity of 10% RH.

The interlayer 32 may be disposed between one of the microstructure 14 (first electrode) or the second electrode 26, and the liquid crystal composition layer 20. That is, as shown in FIG. 4, the second electrode 26, the interlayer 32, and the liquid crystal composition layer 20 are disposed in this order. Alternatively, the second electrode 26, the liquid crystal composition layer 20, and the interlayer 32 may be disposed in this order.

In addition, the radio wave control element 10 may have two or more interlayers 32. For example, an interlayer may be provided between the microstructure 14 (first electrode) and the liquid crystal composition layer 20, and between the liquid crystal composition layer 20 and the second electrode 26.

In addition, an alignment film for aligning the above-described liquid crystal compounds LC in a predetermined state may be used as the interlayer 32.

A material for forming the interlayer 32 is not particularly limited, but is preferably a dielectric, and it is sufficient that the interlayer 32 has sufficient transmittance for radio waves RW. Examples thereof include semiconductors such as silicon, silicon oxide (quartz (SiO₂)), germanium, and chalcogenide glass, polyacrylic resins such as polymethyl methacrylate, cellulose-based resins such as cellulose triacetate, cycloolefin polymers, resins such as polyethylene terephthalate (PET), polycarbonate, and polyvinyl chloride, and glass.

As described above, in a radio wave control element in which a liquid crystal composition layer is disposed between a metasurface structure (first electrode) and a second electrode, and a refractive index of the liquid crystal composition layer is made different for each unit cell by applying different voltages to the unit cells corresponding to a plurality of microstructures constituting the metasurface structure to control the reflection direction of radio waves RW, it is required to shorten the switching time in a case of changing the reflection direction of the radio waves RW. In such a radio wave control element, the change in the alignment state of the liquid crystal compounds in a case where a voltage is applied can be quickly performed by reducing the thickness of the liquid crystal composition layer. That is, the switching time of the reflection directions of the radio waves RW in the radio wave control element can be shortened by reducing the thickness of the liquid crystal composition layer.

However, it was found that in a case where the liquid crystal composition layer is made thin, there is a problem that the loss of the radio wave RW in a case where the radio wave RW is reflected increases. The present inventors have investigated this point and have found that in a case where the distance between the metasurface structure (first electrode) and the second electrode is shortened, the radio wave RW absorption by the liquid crystal composition increases, so that the loss of the radio wave RW increases.

In contrast, the radio wave control element 10 of the embodiment of the present invention has the interlayer 32 in which a maximum change in refractive index per unit voltage in a radio wave having a wavelength in a range of 300 μm to 30 cm is 0.001 (1/V) or less, between one of the metasurface structure 12 (first electrode) or the second electrode 26, and the liquid crystal composition layer 20. As a result, even in a case where the liquid crystal composition layer 20 is made thin, the distance between the first electrode and the second electrode 26 can be increased. Accordingly, in the radio wave control element 10 of the embodiment of the present invention, the thickness of the liquid crystal composition layer is reduced, the switching time of the reflection direction of the radio wave RW in the radio wave control element is shortened and the absorption of the radio wave RW is suppressed. Thus, the loss of the radio wave RW can be reduced.

Here, from the viewpoint of shortening the switching time of the reflection directions of the radio waves RW (improving the response speed) and reducing the loss of the radio wave RW, the thickness of the interlayer 32 is preferably 0.1 to 2 times, more preferably 0.2 to 1.8 times, and still more preferably 0.5 to 1.5 times the thickness of the liquid crystal composition layer 20.

In addition, the dielectric constant of the material constituting the interlayer 32 with respect to the applied voltage is not particularly limited. In a case where the liquid crystal composition layer and the interlayer are arranged in series between the facing electrodes as in a case where the second electrode 26 of the radio wave control element 10 and the microstructure 14 are electrodes, a higher dielectric constant of the interlayer is preferable since the electric field applied to the liquid crystal composition layer can be efficiently increased.

Here, in the above-described example, the radio wave control element 10 is a radio wave control element that reflects the radio wave RW and controls the reflection direction of the radio wave RW. However, the radio wave control element of the embodiment of the present invention is not limited thereto.

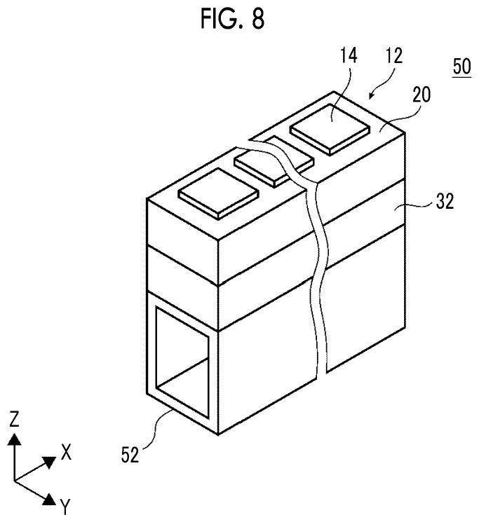

FIG. 7 is a diagram conceptually showing another example of the radio wave control element of the embodiment of the present invention. In addition, FIG. 8 is a perspective view of the radio wave control element shown in FIG. 7.

A radio wave control element 50 shown in each of FIGS. 7 and 8 includes a waveguide 52, an interlayer 32, a liquid crystal composition layer 20, and a metasurface structure 12 (microstructure 14) in this order from the bottom in the drawing. The interlayer 32 and the liquid crystal composition layer 20 are provided on a part of the outer side surface of the waveguide 52. In the radio wave control element 50 shown in each of FIGS. 7 and 8, the waveguide 52 is a waveguide tube consisting of a conductor such as a metal, and the waveguide tube also serves as the second electrode.

Furthermore, in the radio wave control element 50 shown in each of FIGS. 7 and 8, the same parts as those of the radio wave control element 10 shown in FIG. 4 are denoted by the same reference numerals, and the following description will be mainly made for different parts. In addition, in the radio wave control element 50 shown in each of FIGS. 7 and 8, the support is not shown, but the support may be provided.

In the illustrated example, the waveguide 52 is a tubular member having a rectangular cross section, and is a metal waveguide that guides the radio wave RW within a hollow portion. The radio wave RW propagates through the waveguide 52 while forming an electromagnetic field depending on the shape and the dimensions of the waveguide 52, the wavelength (frequency) of the radio wave RW, and the like.

In addition, the waveguide 52 has a plurality of openings 54 that communicate the hollow portion with the outside in a wall portion on a side where the interlayer 32, the liquid crystal composition layer 20, and the microstructure 14 are laminated, that is, on a surface that faces the microstructure 14 to act as the second electrode. The openings 54 are each provided at positions corresponding to the unit cells UC (that is, the microstructures 14).

In a case where the waveguide 52 has a plurality of openings 54, the radio wave RW guided within the hollow portion of the waveguide 52 leaks out from the openings 54 to be released to the outside. In this case, the radio wave RW passes through the interlayer 32 and the liquid crystal composition layer 20. Also in the radio wave control element 50, the traveling direction of the radio wave RW can be controlled by performing the phase modulation, that is, controlling the delay amount of the phase for each unit cell UC, in the same manner as in the radio wave control element 10 shown in FIG. 4. That is, the radio wave control element 50 can control the emission direction of the radio wave RW. In addition, by actively changing the delay amount of the phase in each unit cell UC, it is possible to actively change the emission direction of the radio waves RW.

Here, the radio wave control element 50 of the embodiment of the present invention has the interlayer 32 in which a maximum change in refractive index per unit voltage in a radio wave having a wavelength in a range of 300 μm to 30 cm is 0.001 (1/V) or less, between one of the metasurface structure 12 (first electrode) or the waveguide 52 functioning as the second electrode, and the liquid crystal composition layer 20. As a result, even in a case where the liquid crystal composition layer 20 is made thin, the distance between the first electrode and the second electrode can be increased. Accordingly, in the radio wave control element 50 of the embodiment of the present invention, the thickness of the liquid crystal composition layer is reduced, the switching time of the emission direction of the radio wave RW in the radio wave control element is shortened and the absorption of the radio wave RW is suppressed. Thus, the loss of the radio wave RW can be reduced.

Furthermore, in the example shown in FIG. 8, the cross-sectional shape of the waveguide 52 is a rectangular shape, but the present invention is not limited thereto, and various shapes such as a square shape, a circular shape, and a polygonal shape can be adopted.

In addition, the dimensions of the waveguide 52 are not particularly limited. The length of the waveguide 52 is preferably 1 to 10,000 mm, and more preferably 3 to 3,000 mm.

Moreover, as in the examples shown in FIGS. 7 and 8, in a case where the waveguide 52 also serves as the second electrode, the waveguide 52 can be formed of the same material (conductor) as the above-described material for forming the second electrode 26.

In addition, in the examples shown in FIGS. 7 and 8, the waveguide 52 also serves as the second electrode; however, this is not limiting, and the waveguide and the second electrode may be separate bodies. In a case where the waveguide and the second electrode are separate bodies, the waveguide is disposed on a surface of the second electrode opposite to the liquid crystal composition layer. Also in a case where the waveguide and the second electrode are separate bodies, the second electrode has an opening through which the radio wave RW passes at a position corresponding to each unit cell. In addition, the waveguide is provided with an emission unit that emits the radio wave RW at a position corresponding to the opening of the second electrode.

In a case where the waveguide and the second electrode are separate bodies, in addition to the waveguide tube formed of the above-described conductor, a waveguide capable of guiding radio waves, such as a strip line, a microstrip line, and a coplanar line, which are known in the related art, can be appropriately used as the waveguide.

In addition, the size of the opening formed in the second electrode is preferably 0.01 to 100,000 mm², more preferably 0.02 to 80,000 mm², and still more preferably 0.05 to 50,000 mm².

Moreover, in the example shown in the drawing, a configuration in which one opening formed in the second electrode is provided in each unit cell UC is adopted; however, this is not limiting, and two or more openings may be provided in each unit cell UC.

In addition, the radio wave control element may include a temperature adjusting member that adjusts the temperature of the liquid crystal composition layer. In such an aspect, the alignment state of the liquid crystal compounds in the liquid crystal composition layer can be fixed. Hereinafter, this aspect will be described in detail.

A temperature adjusting member is not particularly limited as long as it is a member that adjusts the temperature of the liquid crystal composition layer 20. The temperature adjusting member is also not limited in a location where it is disposed as long as the temperature adjusting member can effectively adjust the temperature of the liquid crystal composition layer 20. The temperature adjusting member may be disposed in a layer form between any of the members constituting the radio wave control element, or may be disposed outside the radio wave control element.

In addition, the temperature adjusting member may have a heating device that increases the temperature of the liquid crystal composition layer 20, a cooling device that decreases the temperature of the liquid crystal composition layer 20, and the like.

The procedure for fixing the alignment state of the liquid crystal compounds in the liquid crystal composition layer 20 using the radio wave control element having the temperature adjusting member is as follows. Furthermore, as the liquid crystal compound included in the liquid crystal composition layer 20, a compound exhibiting liquid crystallinity in a case where a heating treatment is carried out by the temperature adjusting member is used. Specifically, it is preferable to use a composition that exhibits a nematic phase at any temperature between 50° C. and 150° C., and exhibits a glass state or a smectic phase at any temperature lower than 50° C.

First, the liquid crystal composition layer 20 is heated by the temperature adjusting member in the radio wave control element and transferred to a liquid crystal phase. Next, while maintaining the heat treatment, a voltage is applied between the second electrode 26 and the microstructure 14 to control the alignment direction of the liquid crystal compounds. In this case, the voltage applied to each unit cell UC may be changed to make the alignment state of the liquid crystal compounds different. Thereafter, in a case where the heating treatment and the application treatment are stopped, the temperature is equal to or lower than the transition temperature of the liquid crystal phase, and the alignment state of the liquid crystal compounds is fixed. That is, the state where the liquid crystal compounds are aligned can be maintained even in a case where a voltage is not applied.

In addition, in the radio wave control element, a state with higher aligning properties can be created depending on the type of a liquid crystal compound to be used. For example, in a case where the liquid crystal compound exhibits a nematic phase and also a higher-order liquid crystal phase such as a smectic phase, the higher-order liquid crystal phase can be fixed by rapidly cooling the radio wave control element using the temperature adjusting member.

Hereinafter, a material for forming the liquid crystal composition layer will be described.

The liquid crystal composition layer is a layer consisting of a liquid crystal composition including liquid crystal compounds, in which an alignment state of the liquid crystal compounds included in the liquid crystal composition layer changes depending on a magnitude of an applied voltage. Moreover, the liquid crystal composition may include components other than the liquid crystal compounds. In addition, it is preferable that the liquid crystal composition does not substantially include a solvent. The phrase “substantially not including a solvent” means that the content of the solvent is 5% by mass or less, and preferably 1% by mass or less with respect to the total mass of the liquid crystal composition.

The liquid crystal composition preferably exhibits a nematic phase in the entire range of 10° C. to 50° C. In addition, it is also preferable that the liquid crystal composition exhibits a nematic phase at any temperature between 50° C. and 150° C., and exhibits a glassy state or smectic liquid crystallinity at any temperature lower than 50° C.

In addition, the liquid crystal composition preferably includes an azo compound, and the liquid crystal compound is preferably a liquid crystal compound having an azo structure. In a case where the liquid crystal composition includes an azo compound, Δn (birefringence) of the liquid crystal composition layer can be increased. Therefore, the thickness of the liquid crystal composition layer required for providing the radio waves with a required refractive index, that is, a required phase difference can be further reduced. In a case where the thickness of the liquid crystal composition layer is reduced, the alignment of the liquid crystal compounds changes more rapidly in a case where the applied voltage is changed. As a result, the response speed to the change in the voltage applied to the liquid crystal composition layer can be increased, and the switching of the traveling direction of the incident radio wave can be performed in a shorter time.

The azo compound is not particularly limited as long as it is a compound including an azo structure (—N═N—). The number of azo structures contained in the azo compound is not particularly limited, may be 1 or more, and is preferably 2 or more. The upper limit of the number of azo structures is not particularly limited, but is often 5 or less, and more often 3 or less.

The azo compound may be a compound exhibiting liquid crystallinity or a compound not exhibiting liquid crystallinity, and is preferably the compound exhibiting liquid crystallinity. That is, the azo compound is preferably a liquid crystal compound having an azo structure.

As the azo compound, a compound represented by Formula (1) is preferable.

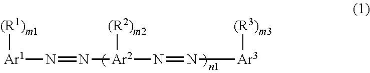

In Formula (1), Ar¹ represents an (m1+1)-valent aromatic ring.

The (m1+1)-valent aromatic ring may be a monocyclic ring or a fused ring of two or more rings. Alternatively, the aromatic ring may be a ring in which a plurality of monocyclic rings are bonded through a single bond (for example, a biphenyl ring or a terphenyl ring).

Examples of the (m1+1)-valent aromatic ring include an aromatic hydrocarbon ring or an aromatic heterocyclic ring.

Examples of the aromatic hydrocarbon ring include a benzene ring, a naphthalene ring, an azulene ring, a fluorene ring, a biphenyl ring, and an anthracene ring. Among these, the benzene ring is preferable.

Examples of the aromatic heterocyclic ring include a pyridine ring, a thiophene ring, a quinoline ring, an isoquinoline ring, and a thiazole ring.

For example, in a case where m1 is 1, Ar¹ represents a divalent aromatic ring.

In Formula (1), Ar² represents an (m2+2)-valent aromatic ring.

The (m2+2)-valent aromatic ring may be a monocyclic ring or a fused ring of two or more rings. Alternatively, the aromatic ring may be a ring in which a plurality of monocyclic rings are bonded through a single bond (for example, a biphenyl ring or a terphenyl ring).

Examples of the (m2+2)-valent aromatic ring include an aromatic hydrocarbon ring or an aromatic heterocyclic ring.

Examples of the aromatic hydrocarbon ring include a benzene ring, a naphthalene ring, an azulene ring, a fluorene ring, a biphenyl ring, and an anthracene ring. Among these, the benzene ring is preferable.

Examples of the aromatic heterocyclic ring include a pyridine ring, a thiophene ring, a quinoline ring, an isoquinoline ring, and a thiazole ring.

For example, in a case where m2 is 1, Ar² represents a trivalent aromatic ring.

In Formula (1), Ar³ represents an (m3+1)-valent aromatic ring.

The (m3+1)-valent aromatic ring may be a monocyclic ring or a fused ring of two or more rings. Alternatively, the aromatic ring may be a ring in which a plurality of monocyclic rings are bonded through a single bond (for example, a biphenyl ring or a terphenyl ring).

Examples of the (m3+1)-valent aromatic ring include an aromatic hydrocarbon ring or an aromatic heterocyclic ring.

Examples of the aromatic hydrocarbon ring include a benzene ring, a naphthalene ring, an azulene ring, a fluorene ring, a biphenyl ring, and an anthracene ring. Among these, the benzene ring is preferable.

Examples of the aromatic heterocyclic ring include a pyridine ring, a thiophene ring, a quinoline ring, an isoquinoline ring, and a thiazole ring.

For example, in a case where m3 is 1, Ar³ represents a divalent aromatic ring.

In Formula (1), R¹, R², and R³ each independently represent a substituent.

In a case of m1≥2, a plurality of R¹'s may be the same as or different from each other, in a case of m2≥2, a plurality of R²'s may be the same as or different from each other, and in a case of m3≥2, a plurality of R³'s may be the same as or different from each other.

The substituent is a monovalent substituent, and examples thereof include an alkyl group, an alkenyl group, an aralkyl group, an aryl group, a heterocyclic group, a halogen atom, a cyano group, a nitro group, a mercapto group, a hydroxy group, an alkoxy group, an aryloxy group, an alkylthio group, an arylthio group, an acyloxy group, an amino group, an alkylamino group, a dialkylamino group, a carboxamide group, a sulfonamide group, a sulfamoylamino group, an oxycarbonylamino group, an oxysulfonylamino group, a ureido group, a thioureido group, an acyl group, an oxycarbonyl group, a carbamoyl group, a sulfonyl group, a sulfinyl group, a sulfamoyl group, a carboxy group (including a salt), a sulfo group (including a salt), and a group obtained by combining these groups. These groups may be further substituted with these groups.

In Formula (1), m1, m2, and m3 each independently represent an integer of 0 to 5. m1 is preferably 1 to 3, m2 is preferably 0 to 1, and m3 is preferably 1 to 3.

In Formula (1), n1 represents an integer of 1 to 4, and is preferably 1 to 3, and more preferably 2 or 3.

In addition, it is preferable that the liquid crystal composition includes dichroic coloring agents, and it is also preferable that the liquid crystal compound is a liquid crystalline dichroic coloring agent. By aligning the dichroic coloring agents in the liquid crystal composition, the refractive index anisotropy with respect to radio waves can be further increased.

The dichroic coloring agent is a substance exhibiting dichroism, and the dichroism means a property in which an absorbance varies depending on a polarization direction.

The dichroic coloring agent may be used alone or in combination of two or more kinds thereof. Above all, the liquid crystal composition preferably includes two or more kinds of dichroic coloring agents. In a case where the liquid crystal composition includes two or more kinds of dichroic coloring agents, the liquid crystal composition preferably includes two to four kinds of dichroic coloring agents, and more preferably includes two or three kinds of dichroic coloring agents.

The dichroic coloring agent preferably exhibits liquid crystallinity. That is, a liquid crystalline dichroic coloring agent is preferable.

Among these, from the viewpoint that the effects of the present invention are more excellent, a compound represented by Formula (X) is preferable as the dichroic coloring agent.

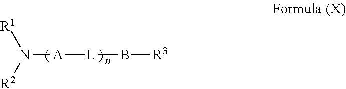

In Formula (X), R¹ and R² each independently represent a linear or branched hydrocarbon group having 1 to 10 carbon atoms, and the hydrocarbon group may include an oxygen atom, a nitrogen atom, or a sulfur atom.

The hydrocarbon group has 1 to 10 carbon atoms, and from the viewpoint that the effects of the present invention are more excellent, the hydrocarbon group preferably has 1 to 8 carbon atoms, and more preferably has 2 to 6 carbon atoms.

The hydrocarbon group is linear or branched, and is preferably linear.

The hydrocarbon may be a saturated hydrocarbon group or an unsaturated hydrocarbon group.

The hydrocarbon group may include an oxygen atom, a nitrogen atom, or a sulfur atom. The hydrocarbon group may include a plurality of atoms selected from the group consisting of an oxygen atom, a nitrogen atom, and a sulfur atom.

For example, the hydrocarbon group may include —O—, —S—, —CO—, —CS—, —CO—O—, —CO—NR¹⁰—, —NR¹⁰—, or a group obtained by combining these groups between carbon atoms or at a terminal.

R¹⁰ represents a hydrogen atom or an alkyl group.

As the hydrocarbon group, an alkyl group, which may include —O—, —S—, —CO—, —CS—, —CO—O—, —CO—NR¹⁰—, —NR¹⁰—, or a group obtained by combining these groups between carbon atoms or at a terminal is preferable.

In Formula (X), R¹ and R² may be bonded to each other to form a ring.

The ring to be formed may be an aliphatic ring or an aromatic ring.

In Formula (X), A and B each independently represent a divalent aromatic ring group.

Examples of the divalent aromatic ring group include a divalent aromatic hydrocarbon ring group and a divalent aromatic heterocyclic group.

The divalent aromatic hydrocarbon ring group is a group obtained by removing two hydrogen atoms from an aromatic hydrocarbon ring. The aromatic hydrocarbon ring may be a monocyclic ring or a fused ring. Examples of the aromatic hydrocarbon ring include a benzene ring, a naphthalene ring, an anthracene ring, a pyrene ring, a phenanthrene ring, and a fluorene ring.

The divalent aromatic heterocyclic group is a group obtained by removing two hydrogen atoms from an aromatic heterocyclic ring. The aromatic heterocyclic ring may be a monocyclic ring or a fused ring. Examples of the aromatic heterocyclic ring include a pyridine ring, a pyrimidine ring, a pyridazine ring, a pyrazine ring, a triazine ring (for example, a 1,2,3-triazine ring, a 1,2,4-triazine ring, and a 1,3,5-triazine ring), a tetrazine ring (for example, a 1,2,4,5-tetrazine ring), a quinoxaline ring, a pyrrole ring, a furan ring, a thiophene ring, an imidazole ring, an oxazole ring, a thiazole ring, a benzopyrrole ring, a benzofuran ring, a benzothiophene ring, a benzimidazole ring, a benzoxazole ring, a benzothiazole ring, a naphthopyrrole ring, a naphthofuran ring, a naphthothiophene ring, a naphthimidazole ring, a naphthoxazole ring, a pyrroloimidazole ring (for example, a 5H-pyrrolo[1,2-a]imidazole ring), an imidazooxazole ring (for example, an imidazo[2,1-b]oxazole ring), a thienothiazole ring (for example, a thieno[2,3-d]thiazole ring), a benzothiadiazole ring, a benzodithiophene ring (for example, a benzo[1,2-b: 4,5-b′]dithiophene ring), a thienothiophene ring (for example, a thieno[3,2-b]thiophene ring), a thiazolothiazole ring (for example, a thiazolo[5,4-d]thiazole ring), a naphthodithiophene ring (for example, a naphtho[2,3-b: 6,7-b′]dithiophene ring, a naphtho[2,1-b: 6,5-b′]dithiophene ring, a naphtho[1,2-b: 5,6-b′]dithiophene ring, and a 1,8-dithiadicyclopenta[b,g]naphthalene ring), a benzothienobenzothiophene ring, a dithieno[3,2-b:2′,3′-d]thiophene ring, and a 3,4,7,8-tetrathiadicyclopenta[a, e]pentalene ring.

In Formula (X), L represents a single bond, —CR═CR—, —C≡C—, —CR═N—, or —N═N—.

R's each independently represent a hydrogen atom, a halogen atom, or an alkyl group having 1 to 6 carbon atoms.

In Formula (X), n represents an integer of 1 to 3, and in a case where n is 2 or 3, a plurality of A's and L's may be the same as or different from each other.

R³ represents a hydrogen atom or a substituent.

The type of the substituent is not particularly limited, and examples thereof include a halogen atom (for example, a fluorine atom, a chlorine atom, a bromine atom, and an iodine atom), a hydrocarbon group (an alkyl group (including a cycloalkyl group, a bicycloalkyl group, and a tricycloalkyl group), an alkenyl group (including a cycloalkenyl group and a bicycloalkenyl group), an alkynyl group, an aryl group, and the like), a heterocyclic group, a cyano group, an isothiocyanate group, a nitro group, an alkoxy group, an aryloxy group, a silyl group, a silyloxy group, a heterocyclic oxy group, an acyloxy group, a carbamoyloxy group, an alkoxycarbonyloxy group, an aryloxycarbonyloxy group, a primary, secondary, or tertiary amino group (including an anilino group), an alkylthio group, an arylthio group, a heterocyclic thio group, an alkyl or an arylsulfinyl group, an alkyl or an arylsulfonyl group, an acyl group, an aryloxycarbonyl group, an alkoxycarbonyl group, an aryl or a heterocyclic azo group, an imide group, a phosphino group, a phosphinyl group, a phosphinyloxy group, a phosphinylamino group, a phosphono group, a carboxy group, a phosphoric acid group, a sulfonic acid group, a hydroxy group, a thiol group, an acylamino group, a carbamoyl group, a ureido group, a boronic acid group, and a group formed by combining these groups.

Among these, the substituent is preferably the alkyl group, the alkoxy group, the cyano group, or the isothiocyanate group, which may include an oxygen atom, a nitrogen atom, or a sulfur atom. The alkyl group may include an oxygen atom, a nitrogen atom, or a sulfur atom. For example, the alkyl group and the alkoxy group may include —O—, —S—, —CO—, —CS—, —CO—O—, —CO—NR¹⁰—, —NR¹⁰—, or a group obtained by combining these groups between carbon atoms. R¹⁰ represents a hydrogen atom or an alkyl group.

The alkyl group and the alkoxy group may include a plurality of —O-'s, —S-'s, —CO-'s, —CS-'s, —CO—O-'s, —CO—NR¹⁰-'s, —NR¹⁰-'s, or groups obtained by combining these groups.

The number of carbon atoms in the alkyl group and the alkoxy group is not particularly limited, and is preferably 1 to 10, and more preferably 1 to 6.

R represents a hydrogen atom or an alkyl group.

The total content of the dichroic coloring agents in the liquid crystal composition is 30% by mass or more with respect to the total mass of the liquid crystal composition. Furthermore, in a case where the liquid crystal composition includes only one kind of dichroic coloring agent as the dichroic coloring agent, the total content of the dichroic coloring agents corresponds to a content of the one kind of dichroic coloring agent with respect to the total mass of the liquid crystal composition. In addition, in a case where the liquid crystal composition includes two or more kinds of dichroic coloring agents, the total content of the dichroic coloring agents corresponds to a total amount of the two or more kinds of dichroic coloring agents.

In the liquid crystal composition layer consisting of the liquid crystal composition including the dichroic coloring agent, a state where the refractive index anisotropy with respect to radio waves is high can be obtained. The details of the reason are not clear, but it is presumed that by increasing the total content of the dichroic coloring agents in the liquid crystal composition layer, the interaction between the dichroic coloring agents increases, and thus the degree of alignment order of the absorption axis due to the absorption skeletons in the dichroic coloring agents can be increased, and as a result, the absorption anisotropy of the dichroic coloring agents affects the increase in the refractive index anisotropy at a wavelength longer than the absorption wavelength.

Furthermore, from the viewpoint that the effects of the present invention are more excellent, the total content of the dichroic coloring agents in the liquid crystal composition is preferably 50% by mass or more, more preferably 80% by mass or more, and still more preferably 90% by mass or more with respect to the total mass of the liquid crystal composition. The upper limit is not particularly limited, and examples thereof include 100% by mass or less.

Hereinbefore, the radio wave control element of the embodiment of the present invention has been described in detail, but the present invention is not limited to the above-described examples, and various improvements and changes may be made without departing from the spirit of the present invention.

### EXAMPLES

Hereinafter, the present invention will be described in more detail with reference to Examples. The materials, the amounts of materials used, the ratios, the treatment details, the treatment procedure, or the like shown in the following Examples can be appropriately modified without departing from the spirit of the present invention. Therefore, the scope of the present invention should not be restrictively interpreted by the following Examples.

A model of the radio wave control element as shown in FIG. 4 was manufactured using optical simulation software. For the simulation, finite element method simulation software “COMSOL Multiphysics” manufactured by COMSOL, Inc. was used.

### Example 1-1

A radio wave control element to be modeled had a structure in which a second electrode, an interlayer, a liquid crystal composition layer, and a microstructure (metasurface structure) were laminated in this order. In addition, the size of one unit cell was set to 11 mm×11 mm, and a configuration in which unit cells were infinitely arranged in the in-plane direction was adopted by applying periodic boundary conditions.

The second electrode and the microstructure were made of copper as a material and had a thickness set to 2 μm. In addition, the size of one microstructure was set to a square shape of 8 mm×8 mm, and the microstructure was disposed at a substantially center position of the unit cell in the in-plane direction.

The liquid crystal composition layer was formed of a composition obtained by mixing the following liquid crystal compound 1-1 and liquid crystal compound 1-3 at a ratio of 50%: 50%. In addition, the thickness of the liquid crystal composition layer was set to 300 μm.

A sample of a liquid crystal composition layer obtained by mixing the following liquid crystal compounds 1-1 and 1-3 was manufactured, and the maximum change in refractive index per unit voltage in radio waves in a wavelength range of 300 μm to 30 cm was measured by the above-described method, and was found to be 0.12 (1/V).

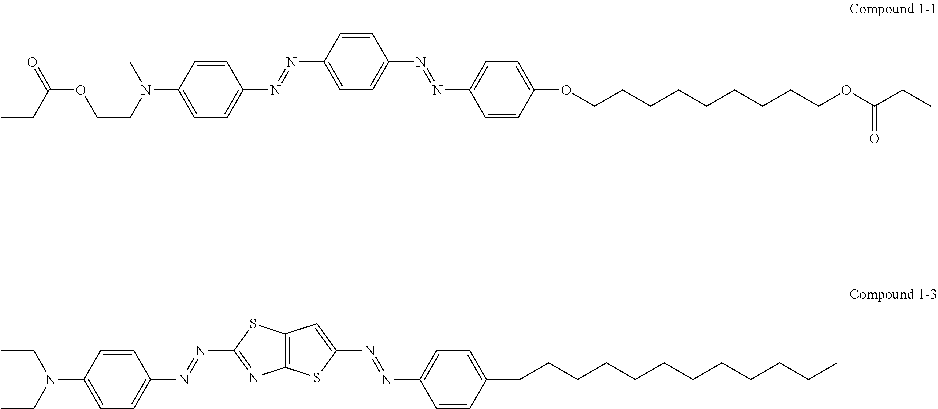

The interlayer was a layer consisting of quartz (SiO₂). In addition, the thickness of the interlayer was set to 300 μm. Therefore, the distance between the microstructure and the second electrode is 600 μm.

A sample of an interlayer consisting of quartz was manufactured, and the maximum change in refractive index per unit voltage in radio waves in a wavelength range of 300 μm to 30 cm was measured by the above-described method, and was found to be 0.0001 (1/V).

### Comparative Example 1-1

A radio wave control element was modeled in the same manner as in Example 1-1, except that the interlayer was not provided and the thickness of the liquid crystal composition layer was set to 600 μm. That is, the distance between the microstructure and the second electrode is 600 μm.

### Comparative Example 1-2

A radio wave control element was modeled in the same manner as in Example 1-1, except that the interlayer was not provided. That is, the distance between the microstructure and the second electrode is 300 μm.

### [Evaluation]

Using simulation software “COMSOL Multiphysics”, a loss of radio waves at 10 GHz in a case where the radio waves at 10 GHz were incident on and reflected from the model of the radio wave control element of each of Examples and Comparative Examples above was calculated. Furthermore, the loss of radio waves in the liquid crystal composition layer is substantially the same regardless of the alignment state of the liquid crystal compounds.

In addition, it is known that the switching time in a case where a voltage is applied to the liquid crystal composition layer to change the alignment state of the liquid crystal compounds is proportional to the square of the thickness. The switching time of the radio wave control element of Comparative Example 1-1 was set to 1 to calculate the switching time of each of Examples and Comparative Examples.

The results are shown in Table 1.

TABLE 1

| | Thickness of liquid | | Evaluation | |
|---|---|---|---|---|
| | crystal composition | Thickness of | | Switching |
| | layer | interlayer | Loss | time |
| Example 1-1 | 300 μm | 300 μm | 53% | 0.25 |
| Comparative | 600 μm | — | 53% | 1 |
| Example 1-1 | | | | |
| Comparative | 300 μm | — | 79% | 0.25 |
| Example 1-2 | | | | |

From Table 1, it can be seen that in Examples of the present invention, both the reduction in the switching time and the suppression of the loss of radio waves can be achieved, as compared with Comparative Examples.

### Example 2-1

A radio wave control element having a waveguide to be modeled had a structure in which a waveguide, an interlayer, a liquid crystal composition layer, and a microstructure (metasurface structure) were laminated in this order. In addition, the waveguide was configured as a copper metal waveguide having a width of 25.4 mm, a height of 12.7 mm, and a length of 80 mm, and three openings having a width of 13.7 mm and a length of 1 mm were provided on the top surface at intervals of 25 mm.

In the microstructure, the material was copper and the thickness was 2 μm. In addition, the size of one microstructure was set to a square shape of 17 mm×17 mm, and the microstructure was disposed directly above the opening of the top surface of the waveguide.

The liquid crystal composition layer and the interlayer were each the same as those in Example 1-1. That is, the thickness of the liquid crystal composition layer is 300 μm and the thickness of the interlayer is 300 μm. Therefore, the distance between the microstructure and the second electrode is 600 μm.

### Comparative Example 2-1

A radio wave control element was modeled in the same manner as in Example 2-1, except that the interlayer was not provided and the thickness of the liquid crystal composition layer was set to 600 μm. That is, the distance between the microstructure and the second electrode is 600 μm.

### Comparative Example 2-2

A radio wave control element was modeled in the same manner as in Example 2-1, except that the interlayer was not provided. That is, the distance between the microstructure and the second electrode is 300 μm.

### [Evaluation]

Using simulation software “COMSOL Multiphysics”, in the model of the radio wave control element of each of Examples and Comparative Examples above, a loss of radio waves at 10 GHz emitted from the opening in a case where the radio waves at 10 GHz were incident on and propagated through the waveguide was calculated.

The results are shown in Table 2.

TABLE 2

| | Thickness of liquid | | Evaluation | |
|---|---|---|---|---|
| | crystal composition | Thickness of | | Switching |
| | layer | interlayer | Loss | time |
| Example 2-1 | 300 μm | 300 μm | 42% | 0.25 |
| Comparative | 600 μm | — | 42% | 1 |
| Example 2-1 | | | | |
| Comparative | 300 μm | — | 75% | 0.25 |
| Example 2-2 | | | | |

From Table 2, it can be seen that in Examples of the present invention, both the reduction in the switching time and the suppression of the loss of radio waves can be achieved, as compared with Comparative Examples.

As can be seen from the above results, the effects of the present invention are obvious.

### EXPLANATION OF REFERENCES

2: radio wave reflection device
10, 50: radio wave control element
12: metasurface structure
14: microstructure (first electrode)
24: support
20: liquid crystal composition layer
26: second electrode
28: power supply
32: interlayer
52: waveguide
54: opening
ANT: antenna
AR1, AR2: area
BL: building
LC: liquid crystal compound
RW: radio wave
UC: unit cell

What is claimed is:

1. A radio wave control element comprising:
a first electrode;
a liquid crystal composition layer; and
a second electrode,
wherein the radio wave control element has a metasurface structure in which a plurality of microstructures are arranged,
the metasurface structure constitutes at least a part of the first electrode, and
an interlayer in which a maximum refractive index change per unit voltage in radio waves in a wavelength range of 300 μm to 30 cm is 0.001 (1/V) or less is provided between one of the first electrode or the second electrode and the liquid crystal composition layer.

2. The radio wave control element according to claim 1, further comprising:
a waveguide that guides radio waves on a side of the second electrode opposite to a liquid crystal composition layer side,
wherein the second electrode has an opening through which the radio waves pass.

3. The radio wave control element according to claim 2,
wherein the second electrode also serves as the waveguide.

4. The radio wave control element according to claim 1,
wherein a thickness of the interlayer is 0.1 to 2 times a thickness of the liquid crystal composition layer.

5. The radio wave control element according to claim 1,
wherein the radio wave control element controls radio waves in a wavelength range of 300 μm to 30 cm.

6. The radio wave control element according to claim 2,
wherein a thickness of the interlayer is 0.1 to 2 times a thickness of the liquid crystal composition layer.

7. The radio wave control element according to claim 2,
wherein the radio wave control element controls radio waves in a wavelength range of 300 μm to 30 cm.

8. The radio wave control element according to claim 3,
wherein a thickness of the interlayer is 0.1 to 2 times a thickness of the liquid crystal composition layer.

9. The radio wave control element according to claim 3,
wherein the radio wave control element controls radio waves in a wavelength range of 300 μm to 30 cm.

10. The radio wave control element according to claim 4,
wherein the radio wave control element controls radio waves in a wavelength range of 300 μm to 30 cm.
